(19) United States
(12) Patent Application Publication
(10) Pub. No.: US 2025/0117358 A1
(43) Pub. Date: Apr. 10, 2025

(54) Heterogenous Acceleration of Workloads using xPUs and FPGAs

(71) Applicant: Nicolas Tausanovitch, Windham, NH (US)

(72) Inventor: Nicolas Tausanovitch, Windham, NH (US)

(21) Appl. No.: 18/990,883

(22) Filed: Dec. 20, 2024

(51) Int. Cl. G06F 15/80; G06F 9/48

(52) U.S. Cl. CPC G06F 15/80; G06F 9/4881

(57) ABSTRACT

The embodiment disclosed herein include a system for a data center that includes processing units (xPUs) and programmable logic devices. The xPUs may implement a design in hardware to perform specialized operations suited for the design. The programmable logic devices may implement different designs based on operations to be performed. For example, a schedule may be generated to process a workload received by the system. The schedule may include multiple phases that may be mapped to either the xPUs or the programmable logic devices based on an efficiency of performing operations of the phases using the xPU or the programmable logic device. In this way, the system may operate at maximum efficiency when processing the workload.

### BACKGROUND

The present disclosure relates generally to programmable logic devices. More particularly, the present disclosure relates to efficiently processing workloads using arrays of programmable logic devices, such as field programmable gate arrays (FPGAs), and arrays of other processing units (xPUs) such as graphics processing units (GPUs), and tensor processing units (TPUs).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Data centers for performing artificial intelligence (AI) and/or high performance computing (HPC) workloads may include one or more systems (e.g., single enclosure systems, single enclosure units) to perform the workload. The systems may include one or more xPUs, such as graphics processing units (GPUs), and/or tensor processing units (TPUs), that perform specific operations. However, there may be operations in AI and/or HPC that use domain-specific acceleration operations that may not align with the core architecture of the xPUs. As such, running these operations may be inefficient, thereby reducing the value of the xPU and/or the system.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of an embodiment of a system including the integrated circuit device of FIG. 1 for a data center, in accordance with an embodiment of the present disclosure;

FIG. 4 is a flow diagram of a schedule generated by the system of FIG. 3 for processing data (e.g., a workload), in accordance with an embodiment of the present disclosure;

FIG. 5 is a table with attributes of the system of FIG. 3 used to generate the schedule of FIG. 4, in accordance with an embodiment of the present disclosure;

FIG. 6 is a flowchart of an example method for scheduling a workload for the system of FIG. 3, in accordance with an embodiment of the present disclosure; and

FIG. 7 is a block diagram of a data processing system (e.g., a data center) including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to systems (e.g., single enclosure systems, single enclosure units) used in data centers for processing artificial intelligence (AI) and high-performance computing (HPC) workloads. The systems may include two or more xPUs (e.g., graphics processing units (GPUs), tensor processing units (TPUs), associative processing units (APUs), vector processing units (VPUs), quantum processing units (QPUs), neural processing units (NPUs), data processing units (DPUs), infrastructure processing units (IPUs), intelligence processing units (IPUs), or the like, where “x” represents any suitable term referring to a particular type of data processing) communicatively coupled via an interconnect (e.g., a high bandwidth interconnect, a high bandwidth coherent interconnect) to share data among the xPUs. The xPUs may implement a design in hardware and perform different operations based on the implemented design. For example, a TPU may be specifically designed for tensor and/or vector operations, such as AI operations (e.g., large language model (LLM) training). In other examples, a GPU may be specifically designed for parallel processing operations, such as parallel processing of image data or AI data (e.g., large language model (LLM) training) and/or a CPU may be specifically designed for processing data and/or instructions. However, there are many operations that do not align with the designs (e.g., core architecture) of the xPUs. As such, running the operations may be inefficient, thereby reducing the value of the xPU and/or the system. Moreover, the xPUs may be limited by a maximum reticle size of a given silicon process node. As such, adding domain specific hardware accelerators for processing operations that do not align with the core architecture to an xPU may decrease the silicon area available for core xPU functions, which may decrease performance and/or efficiency (e.g., efficiency with performance per watt, efficiency with performance per dollar) of the xPU for core AI workloads.

The present embodiments disclosed herein are directed to systems for data centers that with both xPUs and programmable logic devices, such as a field programmable gate array (FPGA). For example, the system may include FPGAs coupled to xPUs via an interconnect. The FPGAs may implement different domain specific accelerators to perform operations that do not align with the core architecture of the xPUs. As such, all of the silicon area of the xPU may be used to implement the core architecture and each xPU may perform the specific operations that it is designed to handle, which may improve the operation efficiency of both the xPU and the system. Additionally, the FPGAs may implement different designs for different workloads. For example, an FPGA may implement a first design to process a first workload and be fully reconfigured or partially reconfigured to implement a second design to process a second workload. The first design may be different from the second design. As such, the FPGAs may provide flexibility for the system and flexibility for the types of workloads the system may handle. Furthermore, the interconnect includes a high bandwidth interconnect that decreases data transfer overhead and latency between the FPGAs and xPUs. Accordingly, the disclosed embodiments may improve processing efficiency and/or increase flexibility of systems used to efficiently process workloads in data centers. In certain embodiments, the systems may include virtual machines (VMs) that run on processors in the data center and/or across multiple data centers in different geographical locations.

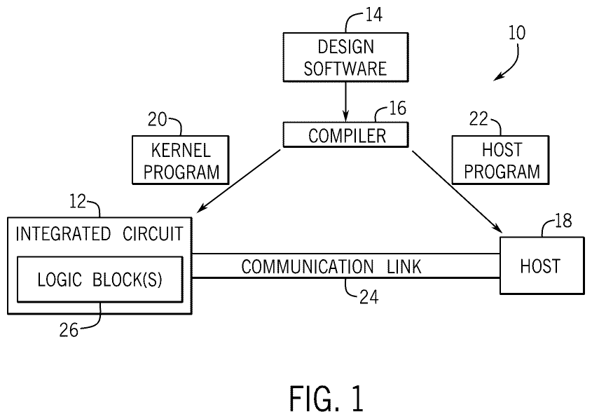

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA). In other examples, the designer may implement the functionality on an application specific integrated circuit (ASIC)). The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system, whether formed from a single integrated circuit or multiple integrated circuits in a package. In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

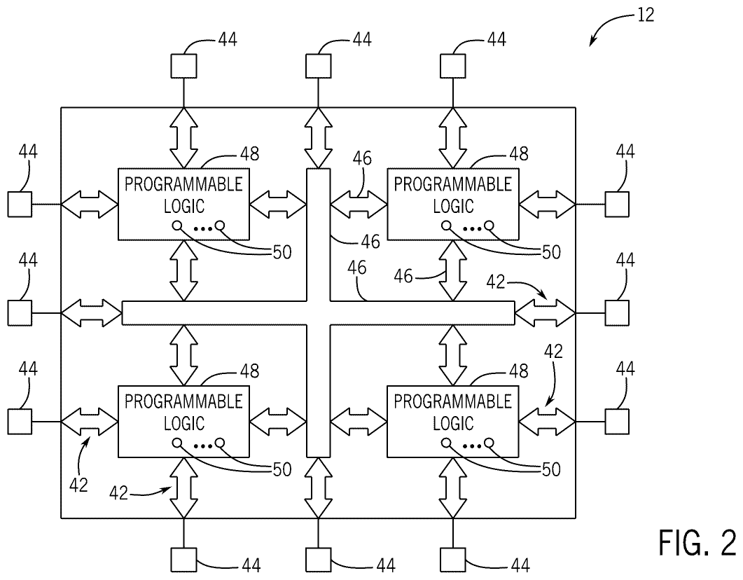

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on integrated circuit device 12. Additionally, interconnection resources 46 may include fixed interconnects (conductive lines) and programmable interconnects (e.g., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re) program (e.g., (re) configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

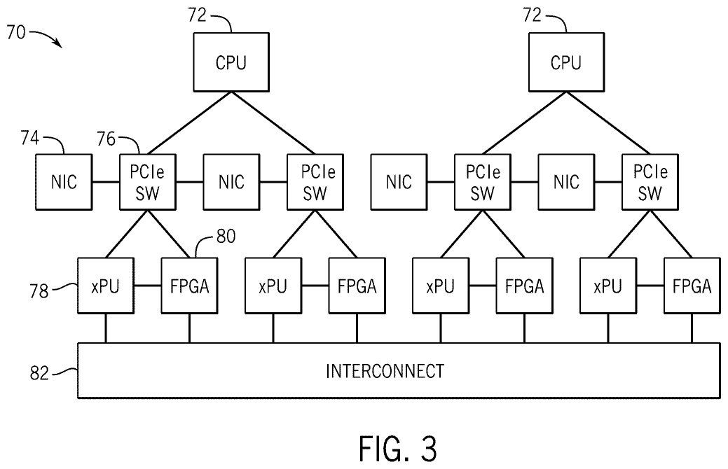

With the foregoing in mind, FIG. 3 illustrates a system 70 including the integrated circuit device 12 for processing data (e.g., workloads) in a data center. For example, the system 70 may be placed on a rack within the data center and used for processing AI and/or HPC workloads. By way of example, the system 70 may be used for AI operations, such as large language model (LLM) training. In another example, the system 70 may perform AI inferences when queried. The system 70 may perform the operations (e.g., process data) with workloads from a variety of different fields, such as genomics, life sciences, oil and gas exploration, and so on. It may be understood that the system 70 and/or the design of the system 70 may extend across multiple different systems (e.g., single enclosure units) within a data center and/or multiple data centers positioned in different geographical locations.

The system 70 may include at least one central processing unit (CPU) 72 to control operation of (e.g., processing of a workload) and/or generate a schedule for processing a workload by the system 70. To this end, the CPU 72 may store an indication of the components and/or a position (e.g., location) of the components within the system 70. The CPU 72 may receive data (e.g., a workload) from a component within the data center via a network interface card (NIC) 74 of one or more NICs 74. In response to receiving data, (e.g., a workload, a portion of the workload, a processed workload), the CPU 72 may generate a schedule for processing the data by mapping the data to one or more components of the system 70. The CPU 72 may determine whether portions (e.g., phases) of the data may be more efficiently processed by a processing unit (xPU) 78 or a programmable logic device, such as field programmable gate array (FGPA) 80. The CPU 72 may instruct transmission of the data within the system 70 via a PCIe switch 76 of one or more PCIe switches 76 based on the schedule. As illustrated, the system 70 includes two CPUs 72, which may provide redundancy in case one CPU 72 malfunctions and/or fails. It may be understood that the system 70 may include any suitable number of CPUs 72 to control operations and/or generate the schedule.

The NICs 74 may communicatively couple the system 70 to other systems 70 positioned proximate to the system 70 within the data center. The NICs 74 may provide data connectivity between the systems 70 of the data center. For example, the NICs 74 may transmit data to and/or receive data from one or more other systems 70.

The PCIe switches 76 may transmit data between the NICs 74 and the xPUs 78 and/or the FPGAs 80 of the system 70. For example, the CPU 72 may instruct the PCIe switches 76 to transmit data received from the NIC 74 to the CPU 72 for processing operations. In another example, the CPU 72 may instruct the PCIe switches 76 to transmit data from the NIC 74 to a respective xPU 78 and/or FPGA 80 based on the data and/or design (e.g., architecture) of the xPU 78 and/or the FPGA 80. In another example, the CPUs 72 may instruct the PCIe switch 76 to transmit data from an xPU 78 to the NIC 74 for storage in a cloud server and/or a database.

The PCIe switches 76 may also transmit data between the xPUs 78 and the FPGAs 80. For example, the CPU 72 may instruct the PCIe switch 76 to transmit data from an xPU 78 coupled to the PCIe switch 76 to another xPU 78 coupled to the PCIe switch 76. In another example, the CPU 72 may instruct the PCIe switch 76 to transmit data from an FPGA 80 to another FPGA 80 coupled to the PCIe switch 76. Still in another example, the CPU 72 may instruct the PCIe switch 76 to transmit data from a xPU 78 to an FPGA 80 or vice versa. Additionally or alternatively, the PCIe switches 76 may transmit data between the xPUs, the FPGAs 80, and the CPUs 72. As such, data may be transmitted within the system 70.

The system 70 may include a combination of xPUs 78 and FPGAs 80 (e.g., the integrated circuit device 12 described with respect to FIGS. 1 and 2) communicatively coupled via an interconnect 82. In the illustrated embodiment, the system 70 includes four xPUs 78 and four FPGAs 80. That is, the system 70 may include a 1:1 ratio of xPUs 78 to FPGAs 80. The interconnect 82 may include a high bandwidth interconnect that transmits data between the xPUs 78 and the FPGAs 80. For example, a first xPU 78 may operate on a portion the data and then transmit processed data to a second xPU 78 and/or an FPGA 80 for additional processing via the interconnect 82. As such, the xPUs 78 and the FPGAs 80 may share data during the processing operations.

The xPUs 78 and/or FPGAs 80 may process the data based on a design (e.g., architecture) implemented by the xPU 78 and/or the FPGA 80. For example, the xPUs 78 may implement a design in hardware and may be software programmable. The xPUs 78 may include any suitable processing unit, such as GPUs, TPUs, CPUs, associative processing units (APUs), vector processing units (VPUs), quantum processing units (QPUs), neural processing units (NPUs), data processing units (DPUs), infrastructure processing units (IPUs), intelligence processing units (IPUs), or the like, where “x” represents any suitable term referring to a particular type of data processing). Additionally, the xPUs 78 may include ASICs. The xPUs 78 may handle specific operations based on the design of the xPU 78 (e.g., a first class of data processing operations). The FPGA 80 may include a programmable logic device that may be programmable at the hardware level. As discussed herein, the FPGA 80 may include programmable elements 50 that may be programmed or reprogrammed (e.g., fully reconfigured, partially reconfigured) to implement a design and/or implement different designs. The FPGA 80 may handle a second class of data processing operations, different from the first class of data processing operations.

The CPUs 72 may implement different designs on the FPGA 80 before, during, and/or after processing operations to improve operation efficiency of the system 70. For example, the CPUs 72 may include a compiler (e.g., the compiler 16 described with respect to FIG. 1) to provide machine-readable instructions to the FPGA 80 for implementing a design in hardware on the FPGA 80. The CPUs 72 may determine the design to implement on the FPGA 80 based on the data to be processed and/or the types of xPUs 78 within the system 70. For example, the CPUs 72 may map portions of the data suitable for the the xPU 78 based on the design implemented by the xPU 78 and/or the type of xPUs 78 in the system and map remaining portions of the data to the FPGA 80. The CPUs 72 may then implement a design on the FPGA 80 suited for processing the remaining portion of the data. As such, the xPU may operate at a higher efficiency level (e.g., in absolute or comparative advantage terms with respect to the FPGA 80). The CPUs 72 may also dynamically adjust the design implemented on the FPGA 80 during processing operations. For example, the CPUs 72 may implement a first design on the FPGA 80 to run a Smith Waterman algorithm, then implement a second design on the FPGA 80 to run operations related to protein folding. To implement the different designs, the CPUs 72 may retrieve a configuration file from a memory and/or a database and transmit the configuration file to the FPGAs 80 via the PCIe switches 76. In certain instances, the CPUs 72 may implement a design associated with an xPU 78 on the FPGA 80 for processing operations. As such, FPGA 80 may provide flexibility to the system 70.

It may be understood that the system 70 of FIG. 3 is illustrative. The system 70 may include any suitable number of CPUs 72, NICs 74, PCIe switches 76, xPUs 78, and/or FPGAs 80. For example, a user may select any suitable number of xPUs 78 and/or FPGAs 80 for the system 70. Additionally or alternatively, the user may adjust the number of xPUs 78 and/or FPGAs 80 by removing the system 70 from the rack, switching any suitable number of xPUs 78 and/or FPGAs 80, and placing the adjusted system 70 back onto the rack for data processing. Furthermore, although the system 70 of FIG. 3 includes the same number of xPUs 78 and FPGAs 80, it may be understood that the system 70 may include any suitable ratio of xPUs 78 to FPGAs 80. In this way, the system 70 may include a modular design that may be easily adjusted by the user and/or controlled dynamically by the CPUs 72. In certain embodiments, the system 70 may include one or more domain-specific hardware accelerators to perform processing operations not suited for the xPUs 78 (e.g., a second class of data processing operations). For example, the domain-specific hardware accelerators may include a hardware encryption or decryption circuit, a video decoder, an audio decoder, and the like.

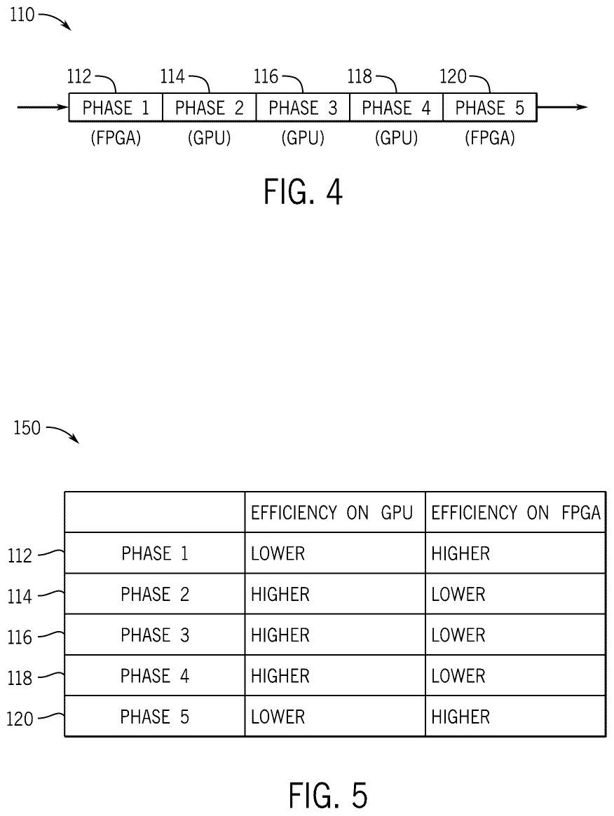

FIG. 4 is a flow diagram of a schedule 110 generated by the system 70 for processing data (e.g., a workload, a portion of the workload). The CPUs 72 may generate a schedule 110 for processing data to train machine learning models, processing an AI and/or HPC workload, or both. The CPUs 72 may generate the schedule 110 prior to transmitting the data to components of the system 70. The CPUs 72 may store the schedule in a memory and may refer to the schedule during processing operations.

The schedule 110 may include one or more phases 112, 114, 116, 118, and 120 that include a series of operations with a common functionality that runs on a large data set for a period of time. The CPUs 72 may map each phase 112, 114, 116, 118, and 120 to an xPU 78 or an FPGA 80 based on a determination of efficiency. In another example, the CPUs 72 may account for the types of xPUs 78, the designs of the xPUs 78, the ratio of xPUs 78 to FPGAs 80, and the like to map portions of the data to the components for processing.

As illustrated, the schedule 110 may include a first phase 112, a second phase 114, a third phase 116, a fourth phase 118, and a fifth phase 120 for processing the data. By way of example, in the area of HPC, such as genomics analysis, the first phase 112 may include mapping operations, the second phase 114 may include alignment operations, the third phase 116 may include variant calling operations, the fourth phase 118 may include recalibration and refinement operations, and the fifth phase 120 may include variant evaluation operations. In another example, for AI training, the first phase 112 may include data reduction and filtering operations, the second phase 114 may include format conversion and labelling operations, the third phase 116 may include iterative training and/or inference operations including matrix multiplication and/or tensor math operations, the fourth phase 118 and/or fifth phase 120 may include data formatting and conversion operations. The CPUs 72 may map the operations of each phase to a component of the system 70 based on the attributes of the system 70 discussed above and further described with respect to FIG. 5. For example, the first phase 112 may be mapped to an FPGA 80, the second phase 114 may be mapped to an xPU (e.g., GPU) 78, a third phase 114 may be mapped to an xPU (e.g., GPU) 78, a fourth phase 118 may be mapped to an xPU (e.g., GPU) 78, and a fifth phase 120 may be mapped to an FPGA 80 based on a comparison between processing efficiency of the xPU 78 and the FPGA 80.

Turning to FIG. 5, the CPUs 72 may generate the schedule 110 based on attributes of the system 70. For example, the CPUs 72 may map highly parallelizable math operations, such as operations with vectors, matrices, and tensors, to the xPUs 78 (e.g., GPUs and/or TPUs). The CPUs 72 may determine a maximum number of tensor and/or vector operations that may be performed by the xPUs 78 (e.g., GPUs and/or TPUs) and determine the portion of the data for allocation based on the maximum number. In certain instances, the CPUs 72 may allocate remaining tensor and/or vector operations to the FPGA 80 so the xPUs 78 may execute processes that it is designed to handle. In another example, the CPUs 72 may map data format conversion and compression operations, genomics algorithms, such as Smith Waterman and/or Hidden Markov modelling, AI inference applications, and/or other HPC workloads that do not map well to xPUs to FPGAs 80. The CPUs 72 may also determine which designs to implement on the FPGAs 80 to complement the xPUs 78 in the data processing based on the mapping. Furthermore, the CPUs 72 may determine points in time to adjust the design implemented by the FPGAs 80, such as via a full reconfiguration of the design or a partial reconfiguration of the design.

By way of example, the table 150 illustrates a comparison between mapping a phase 112, 114, 116, 118, and 120 to either an xPU 78 or an FPGA 80. For example, the first phase 112 may be more efficiently handled by the FPGAs 80 than the xPUs 78. As such, the CPUs 72 may map the first phase 112 onto the FPGAs 80. In another example, the second phase 114, the third phase 116, and the fourth phase 118 may be more efficiently handled by the xPUs 78 than the FPGAs 80. As such, the CPUs 72 may map the second phase 114 onto the xPUs 78, the third phase 116 onto the xPUs 78, the fourth phase 118 onto the xPUs 78. Still in another example, the fifth phase 120 may be more efficiently handled by the FPGAs 80 than the xPUs 78. As such, the CPUs 72 may map the fifth phase 120 onto the FPGAs 80.

It may be understood that the schedule 110 of FIG. 4 and the table 150 of FIG. 5 are merely illustrative examples. For example, the schedule 110 and/or the table 150 may include any suitable number of phases that may be determined based on the data (e.g., workload) to be processed.

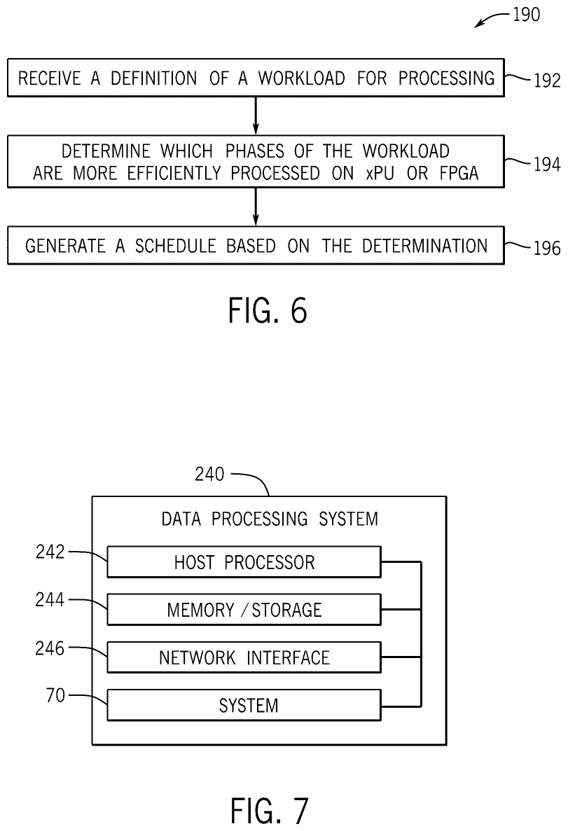

FIG. 6 is a flowchart of an example method 190 for configuring the system 70. The method 190 includes various steps represented by blocks. Although the flowchart illustrates the steps in a certain sequence, it should be understood that the steps may be performed in any suitable order and certain steps may be carried out simultaneously, where appropriate. Further, certain steps or portions of the method 190 may be performed by separate systems or devices. For example, the method 190 may be performed by the compiler 16, the CPUs 72, or any suitable processor.

At block 192, the compiler 16 may receive a definition of a workload for processing. For example, the compiler 16 may receive the workload from a component within the data center, a user, or both.

At block 194, the compiler 16 may determine which phases of the workload are more efficiently processed on a xPU 78 or a FPGA 80. For example, the compiler 16 may compare an efficiency for processing a phase on an xPU 78 to an efficiency for processing the phase on an FPGA 80. In another example, the compiler 16 may determine which operations may be performed during the phase and determine whether the operations are more efficiently performed by the xPU 78 or the FPGA 80.

At block 196, the compiler 16 may generate a schedule based on the determination. The compiler 16 may map the phase to the xPU 78 based on a determination that the xPU 78 may process the phase more efficiently than the FPGA 80 or vice versa. In certain instances, the compiler 16 may map the phase to either an xPU 78 or an FPGA 80 based on determining that the remaining components are already processing data. As such, the xPU 78 and/or the FPGA 80 may be the only available component to process the data. By running the data on both xPUs 78 and FPGAs 80, the system 70 may allow the xPUs 78 to operate at a maximum efficiency, thereby improving efficiency of the xPUs 78 and the system 70. The FPGAs 80 may process the data and/or perform operations that fall outside of the ability of the xPUs to handle efficiently, which may be efficiently handled by the FPGAs 80.

Bearing the foregoing in mind, the system 70 may be a component included in a data processing system and/or data center, such as a data processing system 240, shown in FIG. 7. The data processing system 240 may include the system 70, a host processor 242 (e.g., a processor), memory and/or storage circuitry 244, and a network interface 246. The data processing system 240 may include more or fewer components (e.g., electronic display, designer interface structures, ASICs). Moreover, any of the circuit components depicted in FIG. 7 may include integrated circuits (e.g., integrated circuit device 12). The host processor 242 may include any of the foregoing processors that may manage a data processing request for the data processing system 240 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 244 may include random access memory (RAM), read-only memory (ROM), one or more hard drives, flash memory, or the like. The memory and/or storage circuitry 244 may hold data to be processed by the data processing system 240. In some cases, the memory and/or storage circuitry 244 may also store configuration programs (bit streams) for programming one or more components of the system 70. The network interface 246 may allow the data processing system 240 to communicate with other electronic devices. The data processing system 240 may include several different packages or may be contained within a single package on a single package substrate. For example, components of the data processing system 240 may be located on several different packages at one location (e.g., a data center) or multiple locations. For instance, components of the data processing system 240 may be located in separate geographic locations or areas, such as cities, states, or countries.

In one example, the data processing system 240 may be part of a data center that processes a variety of different requests. For instance, the data processing system 240 may receive a data processing request via the network interface 246 to perform encryption, decryption, machine learning, video processing, voice recognition, image recognition, data compression, database search ranking, bioinformatics, network security pattern identification, spatial navigation, digital signal processing, or some other specialized task.

The above discussion has been provided by way of example. Indeed, the embodiments of this disclosure may be susceptible to a variety of modifications and alternative forms. As discussed herein, the system 70 may include any suitable number of CPUs 72, NICs 74, PCIe switches 76, xPUs 78, and/or FPGAs 80. Furthermore, the data may be divided into any suitable number of phases that may be mapped to either an xPU 78 or an FPGA 80 for processing.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

EXAMPLE EMBODIMENT 1. A system for a data center including a set of first specialized processing units implementing a first design in hardware to perform a first class of data processing operations; a set of programmable logic devices configurable to implement a plurality of additional designs and perform a second class of data processing operations; and a central processing unit (CPU). The CPU to perform operations including receiving data; causing the set of programmable logic devices to be configured to implement one or more of the plurality of additional designs; and instructing the set of programmable logic devices and the set of first specialized processing units to perform the first class of data processing operation and the second class of data processing operations, respectively.

EXAMPLE EMBODIMENT 2. The system of example embodiment 1, wherein the first class of data processing operations comprises tensor operations, matrix multiplication operations, or both.

EXAMPLE EMBODIMENT 3. The system of example embodiment 1, wherein the first class of data processing operations comprises format conversion operations, labelling operations, or both.

EXAMPLE EMBODIMENT 4. The system of example embodiment 1, wherein the CPU is to perform operations comprising directing the data to the set of programmable logic devices or the set of first specialized processing units based on an efficiency of performing a first data processing operation using the set of programmable logic devices relative to performing the first data processing operation using the set of first specialized processing units

EXAMPLE EMBODIMENT 5. The system of example embodiment 1, wherein the set of specialized processing units comprises graphics processing units (GPUs), tensor processing units (TPUs), associative processing units (APUs), vector processing units (VPUs), quantum processing units (QPUs), neural processing units (NPUs), data processing units (DPUs), infrastructure processing units (IPUs), intelligence processing units (IPUs), or any combination thereof.

EXAMPLE EMBODIMENT 6. The system of example embodiment 1, comprising a set of second specialized processing units implementing a second design in hardware to perform a third class of data processing operations.

EXAMPLE EMBODIMENT 7. The system of example embodiment 1, comprising a domain-specific hardware accelerator to perform a third class of data processing operations, wherein the third class of data processing operations is different from the first class of data processing operations.

EXAMPLE EMBODIMENT 8. The system of example embodiment 1, wherein the CPU is to perform operations comprising causing each programmable logic device of the set of programmable logic devices to implement a first additional design of the plurality of additional designs during a first phase of the data processing operation.

EXAMPLE EMBODIMENT 9. The system of example embodiment 1, wherein the CPU is to perform operations including causing a first programmable logic device of the set of programmable devices to implement a first additional design of the plurality of additional designs during a first phase of the data processing operation; and causing the first programmable logic device to implement a second additional design during a second phase of the data processing operation.

EXAMPLE EMBODIMENT 10. The system of example embodiment 1, wherein each first specialized processing unit of the set of first specialized processing unit does not implement any design of the plurality of additional designs in hardware.

EXAMPLE EMBODIMENT 11. A non-transitory, computer-readable medium comprising instructions, that when executed by one or more processors, causes the one or more processors to perform operations including receiving a definition of a workload; determining which phases of the workload are more efficiently processed on a plurality of programmable logic devices or a plurality of processing units comprising TPUs, GPUs, or any combination thereof; and generating a schedule based on the determination, wherein the schedule comprises a plurality of phases for processing the workload.

EXAMPLE EMBODIMENT 12. The non-transitory, computer-readable medium of example embodiment 11, wherein the instructions, when executed by the one or more processors, cause the one or more processors to: determine a first phase of the plurality of phases is more efficiently processed by the plurality of processing units based on a comparison between operations of the first phase and an architecture of at least one processing unit of the plurality of processing units; and schedule the first phase for the at least one processing unit of the plurality of processing units.

EXAMPLE EMBODIMENT 13. The non-transitory, computer-readable medium of example embodiment 11, wherein the instructions, when executed by the one or more processors, cause the one or more processors to: determine a first phase of the plurality of phases is more efficiently processed by at least one programmable logic device of the plurality of programmable logic devices based on a comparison between operations of the first phase and an architecture of at least one processing unit of the plurality of processing units; and schedule the first phase for the at least one programmable logic device.

EXAMPLE EMBODIMENT 14. The non-transitory, computer-readable medium of example embodiment 11, wherein the instructions, when executed by the one or more processors, cause the one or more processors to: determine a first phase of the plurality of phases is not efficiently processed by either a first processing unit of the plurality of processing units or a first programmable logic device of the plurality of programmable logic devices based on a first comparison between operations of the first phase and an architecture of the first processing unit and a second comparison between the operations of the first phase and a first design implemented by the first programmable logic device; determine a second design to be implemented by the first programmable logic device based on the operations of the first phase; and schedule the first phase to be performed the first programmable logic device in response to determining the second design.

EXAMPLE EMBODIMENT 15. The non-transitory, computer-readable medium of example embodiment 11, wherein the instructions, when executed by the one or more processors, cause the one or more processors to determine a first design to implement on at least one programmable logic device of the plurality of programmable logic devices during a first phase of the plurality of phases; and determine a second design to implement on the at least one programmable logic device during a second phase of the plurality of phases.

EXAMPLE EMBODIMENT 16. A system for a data center including a set of specialized processing units to perform a first class of data processing operations; a set of programmable logic devices configurable to implement a plurality of additional designs; a plurality of switches respectively coupled to the set of specialized processing units and the set of programmable logic devices, wherein each switch of the plurality of switches transmits data between a processing unit of the set of processing units and a programmable logic device of the set of programmable logic devices; and a central processing unit coupled to the set of specialized processing units and the set of programmable logic devices, wherein the central processing unit perform operations including receiving a schedule comprising a plurality of phases for processing a workload; and processing the workload based on the schedule by directing the data to the set of specialized processing units or the set of programmable logic devices based on the schedule via the plurality of switches.

EXAMPLE EMBODIMENT 17. The system of example embodiment 16, wherein the central processing unit performs operations including causing at least one programmable logic device of the set of programmable logic devices to implement a first additional design of the plurality of additional designs prior to a first phase of the plurality of phases; and causing the at least one programmable logic device to implement a second additional design of the plurality of additional designs prior to a second phase of the plurality of phases.

EXAMPLE EMBODIMENT 18. The system of example embodiment 17, wherein the central processing unit performs operations including transmitting, via a switch of the plurality of switches, a first configuration bitstream indicative of the first additional design to the at least one programmable logic device to cause the at least one programmable logic device to implement the first additional design; and transmitting, via a switch of the plurality of switches, a second configuration bitstream indicative of the second additional design to the at least one programmable logic device to cause the at least one programmable logic device to implement the second additional design.

EXAMPLE EMBODIMENT 19. The system of example embodiment 16, wherein the set of specialized processing units performs a first class of data processing operations and the set of programmable logic devices performs a second class of data processing operations, wherein the first class of data processing operations is different from the second class of data processing operations.

EXAMPLE EMBODIMENT 20. The system of example embodiment 16, wherein the central processing unit performs operations including transmitting, via a network interface chip and the plurality of switches, a processed workload by the set of specialized processing units and the set of programmable logic devices to a database or another system of the data center in response to completing the schedule.

What is claimed is:

1. A system for a data center comprising:
a set of first specialized processing units implementing a first design in hardware to perform a first class of data processing operations;
a set of programmable logic devices configurable to implement a plurality of additional designs and perform a second class of data processing operations; and
a central processing unit (CPU) to perform operations comprising:
receiving data;
causing the set of programmable logic devices to be configured to implement one or more of the plurality of additional designs; and
instructing the set of programmable logic devices and the set of first specialized processing units to perform the first class of data processing operation and the second class of data processing operations, respectively.

2. The system of claim 1, wherein the first class of data processing operations comprises tensor operations, matrix multiplication operations, or both.

3. The system of claim 1, wherein the first class of data processing operations comprises format conversion operations, labelling operations, or both.

4. The system of claim 1, wherein the CPU is to perform operations comprising directing the data to the set of programmable logic devices or the set of first specialized processing units based on an efficiency of performing a first data processing operation using the set of programmable logic devices relative to performing the first data processing operation using the set of first specialized processing units.

5. The system of claim 1, wherein the set of specialized processing units comprises graphics processing units (GPUs), tensor processing units (TPUs), associative processing units (APUs), vector processing units (VPUs), quantum processing units (QPUs), neural processing units (NPUs), data processing units (DPUs), infrastructure processing units (IPUs), intelligence processing units (IPUs), or any combination thereof.

6. The system of claim 1, comprising a set of second specialized processing units implementing a second design in hardware to perform a third class of data processing operations.

7. The system of claim 1, comprising a domain-specific hardware accelerator to perform a third class of data processing operations, wherein the third class of data processing operations is different from the first class of data processing operations.

8. The system of claim 1, wherein the CPU is to perform operations comprising causing each programmable logic device of the set of programmable logic devices to implement a first additional design of the plurality of additional designs during a first phase of the data processing operation.

9. The system of claim 1, wherein the CPU is to perform operations comprising:
causing a first programmable logic device of the set of programmable devices to implement a first additional design of the plurality of additional designs during a first phase of the data processing operation; and
causing the first programmable logic device to implement a second additional design during a second phase of the data processing operation.

10. The system of claim 1, wherein each first specialized processing unit of the set of first specialized processing unit does not implement any design of the plurality of additional designs in hardware.

11. A non-transitory, computer-readable medium comprising instructions, that when executed by one or more processors, causes the one or more processors to perform operations comprising:
receiving a definition of a workload;
determining which phases of the workload are more efficiently processed on a plurality of programmable logic devices or a plurality of processing units comprising TPUs, GPUs, or any combination thereof; and
generating a schedule based on the determination, wherein the schedule comprises a plurality of phases for processing the workload.

12. The non-transitory, computer-readable medium of claim 11, wherein the instructions, when executed by the one or more processors, cause the one or more processors to:
determine a first phase of the plurality of phases is more efficiently processed by the plurality of processing units based on a comparison between operations of the first phase and an architecture of at least one processing unit of the plurality of processing units; and
schedule the first phase for the at least one processing unit of the plurality of processing units.

13. The non-transitory, computer-readable medium of claim 11, wherein the instructions, when executed by the one or more processors, cause the one or more processors to:
determine a first phase of the plurality of phases is more efficiently processed by at least one programmable logic device of the plurality of programmable logic devices based on a comparison between operations of the first phase and an architecture of at least one processing unit of the plurality of processing units; and
schedule the first phase for the at least one programmable logic device.

14. The non-transitory, computer-readable medium of claim 11, wherein the instructions, when executed by the one or more processors, cause the one or more processors to:
determine a first phase of the plurality of phases is not efficiently processed by either a first processing unit of the plurality of processing units or a first programmable logic device of the plurality of programmable logic devices based on a first comparison between operations of the first phase and an architecture of the first processing unit and a second comparison between the operations of the first phase and a first design implemented by the first programmable logic device;
determine a second design to be implemented by the first programmable logic device based on the operations of the first phase; and
schedule the first phase to be performed the first programmable logic device in response to determining the second design.

15. The non-transitory, computer-readable medium of claim 11, wherein the instructions, when executed by the one or more processors, cause the one or more processors to:
determine a first design to implement on at least one programmable logic device of the plurality of programmable logic devices during a first phase of the plurality of phases; and
determine a second design to implement on the at least one programmable logic device during a second phase of the plurality of phases.

16. A system for a data center comprising:
a set of specialized processing units to perform a first class of data processing operations;
a set of programmable logic devices configurable to implement a plurality of additional designs;
a plurality of switches respectively coupled to the set of specialized processing units and the set of programmable logic devices, wherein each switch of the plurality of switches transmits data between a processing unit of the set of processing units and a programmable logic device of the set of programmable logic devices; and
a central processing unit coupled to the set of specialized processing units and the set of programmable logic devices, wherein the central processing unit perform operations comprising:
receiving a schedule comprising a plurality of phases for processing a workload; and
processing the workload based on the schedule by directing the data to the set of specialized processing units or the set of programmable logic devices based on the schedule via the plurality of switches.

17. The system of claim 16, wherein the central processing unit performs operations comprising:
causing at least one programmable logic device of the set of programmable logic devices to implement a first additional design of the plurality of additional designs prior to a first phase of the plurality of phases; and
causing the at least one programmable logic device to implement a second additional design of the plurality of additional designs prior to a second phase of the plurality of phases.

18. The system of claim 17, wherein the central processing unit performs operations comprising:
transmitting, via a switch of the plurality of switches, a first configuration bitstream indicative of the first additional design to the at least one programmable logic device to cause the at least one programmable logic device to implement the first additional design; and
transmitting, via a switch of the plurality of switches, a second configuration bitstream indicative of the second additional design to the at least one programmable logic device to cause the at least one programmable logic device to implement the second additional design.

19. The system of claim 16, wherein the set of specialized processing units performs a first class of data processing operations and the set of programmable logic devices performs a second class of data processing operations, wherein the first class of data processing operations is different from the second class of data processing operations.

20. The system of claim 16, wherein the central processing unit performs operations comprising:
transmitting, via a network interface chip and the plurality of switches, a processed workload by the set of specialized processing units and the set of programmable logic devices to a database or another system of the data center in response to completing the schedule.
